(19) United States
(12) Patent Application Publication
(10) Pub. No.: US 2006/0288352 A1
(43) Pub. Date: Dec. 21, 2006

(54) Data Processing Method and System

(75) Inventor: Matthew Paul Lucas, Romsey, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/419,775

(22) Filed: May 23, 2006

(30) Foreign Application Priority Data
Jun. 15, 2005 (GB) 0512186.8

(51) Int. Cl. G06F 9/46

(52) U.S. Cl. 719/328

(57) ABSTRACT

A data processing method for operating a sample program and a related application programming interface comprises executing instructions of the sample program, and, for each specific instruction consisting of a call to the related application programming interface, accessing information embedded in the application programming interface relating to the specific instruction and presenting the information relating to the specific instruction.

### FIELD OF THE INVENTION

The invention relates to a method of using source code parsing and aspect orientation to provide application programming interface information.

### BACKGROUND

Many software programs use Application Programming Interfaces (APIs) that allow other developers to write software programs that make use of the services of the API. In order to make use of an API, developers need to learn the exact syntax of the methods provided by the API and the context in which they can be used. This information is provided through a combination of programming samples and API documentation.

Programming samples tend to show the how the API can be used by demonstrating exemplary scenarios in which the API can be used and exposing the sample source code. Samples can be logically distant from the API such as a stock ticker program that happens to make use of a publish/subscribe API, through to being quite closely coupled to the underlying interface such as an API exerciser that provides a graphical user interface that maps user actions directly onto API methods. Samples can also be relatively large such as fully functioning applications to just a few lines long such as demonstrations of a particular class or method call.

Samples are useful when learning to use a new API because programmers can examine the source code of the sample and see, from this, directly the sequence of actions required to achieve the desired effect by the API. The problem is that by running sample applications, particularly large or logically distant ones, the API is effectively abstracted away from the programmer through the sample's user interface, and the programmer has additionally to learn what the sample is doing in order to map the application down to API actions. Therefore, the programmer has to run the sample application in conjunction with viewing its source code, and from this learn the links between the two in order to completely understand the operation of the sample and the underlying API.

It is arguable that samples which are more closely coupled to the API are better, because with these samples it is easier to map user actions to the interface that the developer is attempting to learn. However, the drawback of these samples is that they tend not to reflect real-world scenarios in which the API is expected to be used, and thus do not demonstrate many design considerations that developers would need to understand when designing a solution based on the API. The same is true of small (individual class or method) sample applications; while the source provides education on particular areas of the API, they tend to be too small to be of any real use.

API documentation can be used to solve many of these problems. Good documentation will describe both high level scenarios in which APIs can be used and also individual method signatures and usage information. However, documentation alone cannot provide the benefits of viewing and running sample applications, as it is impractical to view more than a few lines of source in documentation without losing the hands-on benefits of sample applications described above. It is also the case that documentation can become outdated, particularly when changes are made to the API being studied.

### SUMMARY

According to a first aspect of the present invention, there is provided a data processing method for operating a sample program and a related application programming interface, comprising: executing instructions of the sample program; and, for each specific instruction consisting of a call to the related application programming interface, accessing information associated with the application programming interface relating to the specific instruction and presenting the information relating to the specific instruction.

According to a second aspect of the present invention, there is provided a data processing system comprising an executing environment for operating a sample program and a related application programming interface, and a displays device, the executing environment arranged to execute instructions of the sample program, and, for each specific instruction consisting of a call to the related application programming interface, to access information associated with the application programming interface relating to the specific instruction, the display device arranged to present the information relating to the specific instruction.

According to a third aspect of the present invention, there is provided a computer program product on a computer readable medium, the computer program product for operating a data processing system and comprising code for operating a sample program and a related application programming interface comprising: executing instructions of the sample program; and, for each specific instruction consisting of a call to the related application programming interface, accessing information associated with the application programming interface relating to the specific instruction and presenting the information relating to the specific instruction.

Note, the information associated with the application programming interface may be separate from the API (e.g., in a separate database) or may be actually embedded in the application programming interface.

Owing to the invention, it is possible to associate (e.g., embed) and display additional API documentation with an application (the sample program) that uses an API. The result is an application whose coupling between the API and the application is kept relatively low, is resilient to changes in the interface yet still provides detailed, relevant information to a user wishing to learn the API. The API documentation is necessarily derived from the source code of the API, because this, unlike externally generated documentation, automatically reflects the coded API. This helps ensure that the information provided is correct.

The associated information is derived directly from the API source at build time without any change to the sample program, and the sample program does not need to be aware that documentation is available for specific instruction calls within the API.

Advantageously, the sample program includes a user controllable rule controlling the access of the information embedded in the application programming interface relating to the specific instruction. This rule can use aspect-oriented programming methodologies. In several programming languages, there is an ability to include API documentation inside the source code. For example, the Javadoc syntax for Java™ source and (to a lesser extent) Doxygen for C/C++ provide this functionality. A preferred implementation of the invention uses these formats as API source code that conforms to these standards, and can use the invention unaltered. Java and all Java-based trademarks and logos are trademarks of Sun Microsystems, Inc. in the United States, other countries, or both.

When the sample program is built and packaged by the developer of the API, the source code of the API must be available. At this time, a separate application is invoked which extracts the API documentation for each public method in the API and converts it into a resource format parseable by the sample. The suggested format for a Java solution is a property resource bundle, whose keys uniquely identify public method names and whose values contain the documentation. An alternative implementation would be to directly use the output generated by the Javadoc/Doxygen compilation tools, together with a persistent structure that maps public method names to locations in the Javadoc/Doxygen documentation output.

When the sample program is delivered to third party developers, the API source is not necessarily available but the resource files that contain the API documentation are. This is to preserve the confidentiality of source materials. In addition, the sample is modified so that whenever a method is invoked whose signature appears in the previously created resource files, the documentation relevant to that method is displayed by the application. The information is displayed in a non-specified format, which may include invocation specific parameters such as the value passed to the API, or the return code.

The sample program must be able to perform this look-up whenever any method is invoked, by using aspect-orientation to hook into every method invocation made by the sample program. Without making use of aspect-orientation, the check would need to be manually added to each method invocation, which would be unacceptable as this increases the complexity of the code, reduces its maintainability and once more increases the coupling between the API and the sample program, all of which were drawbacks with existing alternative solutions, which the invention aims to remove.

Preferably the application programming interface consists of a source module comprising source code and said information embedded in the application programming interface. By providing a source module with the source code for the API and the information for each API instruction, a simple and efficient API is provided that includes the relevant documentation on each instruction.

Ideally, the step of accessing information associated with the application programming interface for each specific instruction comprises combining a plurality of individual information components into a single application programming interface documentation module. If several specific instructions, each being calls to the API, are made substantially simultaneously, then it is advantageous to obtain the information from the API about all of those instructions at the same time and conglomerate the information into a single application programming interface documentation module. This is a more efficient use of processing and display resources.

Preferably, the system is further arranged to present the executing instructions of the sample program. The display device can most efficiently also display the calls to the API to assist the user in understanding the relationship between the sample program and the calls to the API made by that program.

### BRIEF DESCRIPTION OF THE DRAWINGS

Embodiments of the invention will now be described by way of example only, with reference to the drawings, in which:

FIG. 1 is a schematic diagram of a data processing system;

FIG. 2 is an example of a screen shot of the display device of the data processing system of FIG. 1;

FIG. 3 is a flow diagram of a data processing method; and

FIG. 4 is a sample of an API showing code and embedded information.

### DETAILED DESCRIPTION

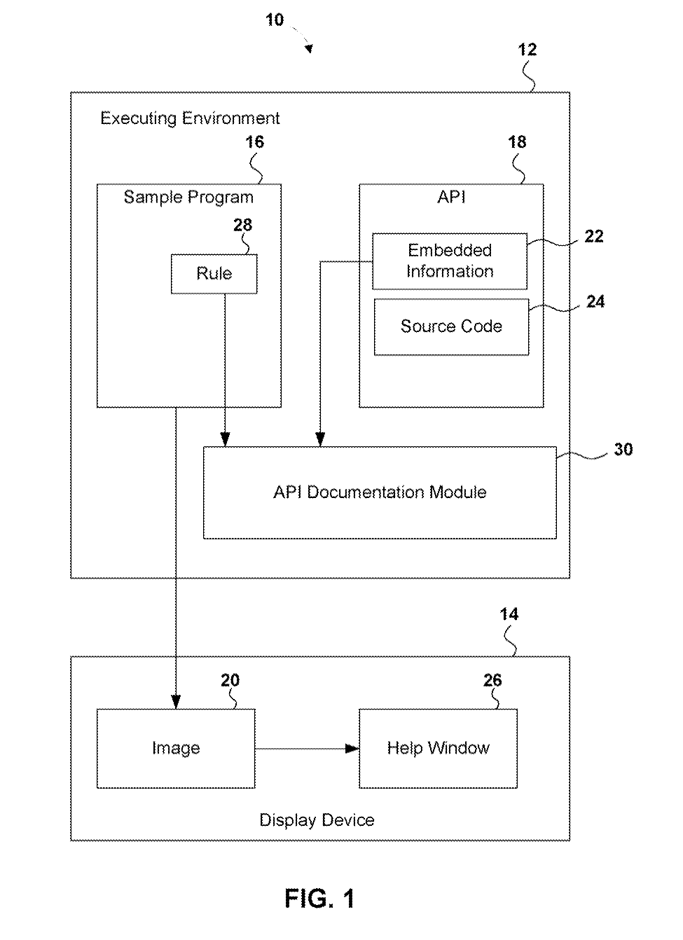

FIG. 1 shows a data processing system 10, which comprises an executing environment 12 and a display device 14. The executing environment 12 is for operating, a sample program 16 and a related application programming interface 18. The executing environment 12 is arranged to execute instructions of the sample program 16 and the display device will display a corresponding image 20 of the running sample program.

The system shown in FIG. 1 can occur, for example, when a programmer is learning to use a new API 18, and is using the sample program 16 to familiarize himself or herself with the workings of the API 18. An API will normally have a series of API-specific instructions, and an API will be provided with several different sample programs to illustrate the workings and interactions of the various instructions.

The executing environment 12 is arranged, for each, specific instruction within the sample program 16 that consists of a call to the related API 18, to access information 22 embedded in the API 18. This information 22 relates to the specific instruction and is linked to the source code 24 within the module for the API 18. The display device 14 is arranged to present the information 22 relating to the specific instruction, in the form of a help window 26. Therefore as users interact with the sample program 16, they will see on the display device 14, in addition to the image 20 of the sample program 16, a help windows 26 which will display information concerning the calls that the sample program 16 is making to the API 18.

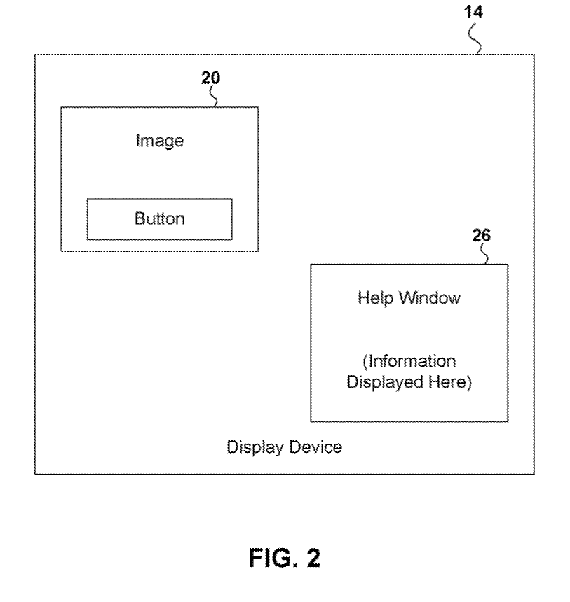

Many sample programs 16 are solely designed to illustrate the workings of a single call to an API 18. The image 20 will include a button that the user will access in a conventional manner with a computer mouse, the pressing of the button simulating the action of a single specific call to the API 18. FIG. 2 shows an example of how a display device 14 would look when the executing environment 12 is running the sample program 16 and the related API 18.

In FIG. 2 there is shown on the display device 14 the image 20 of the sample program 16 and the help window 26 of the information 22 that has been recalled from the API 18. The display device shown in this Figure shows an API of IBM Corporation called the MQI (part of the WebSphere® MQ product), as it would work for the instruction call “MQQueue.put ( )”, which is a specific instruction call of that API. The sample program 16 called “MQ Postcard” invokes the action of the “put” instruction of the API 16.

When the user presses the send button on the image 20, the sample program 16 will continue to be run by the executing environment 12, but there will also be information 22 called from the API 18 and displayed by the display device 14 in the form of the help window 26. The executing environment 12 will achieve the accessing of the information under the control of a rule 28, which can follow common aspect orientated programming techniques. This rule 28 will effectively state that any action by the sample program 16 that involves a call to the API 18, will further involve the call of the information 22.

The rule 28 is user controlled, so that the programmer can switch on and off the feature of the running of the sample program 16 that calls the information 22 from the API 18 for display by the display device 14 in the form of the help window 26. In many situations, the rule 28 will provide for the conglomeration of multiple information components 22 into a single API documentation module 30, which is used to generate the help window 26. This will occur when sample programs are being used that have more complicated action being demonstrated, which involve multiple calls to the API 18, using different instruction calls.

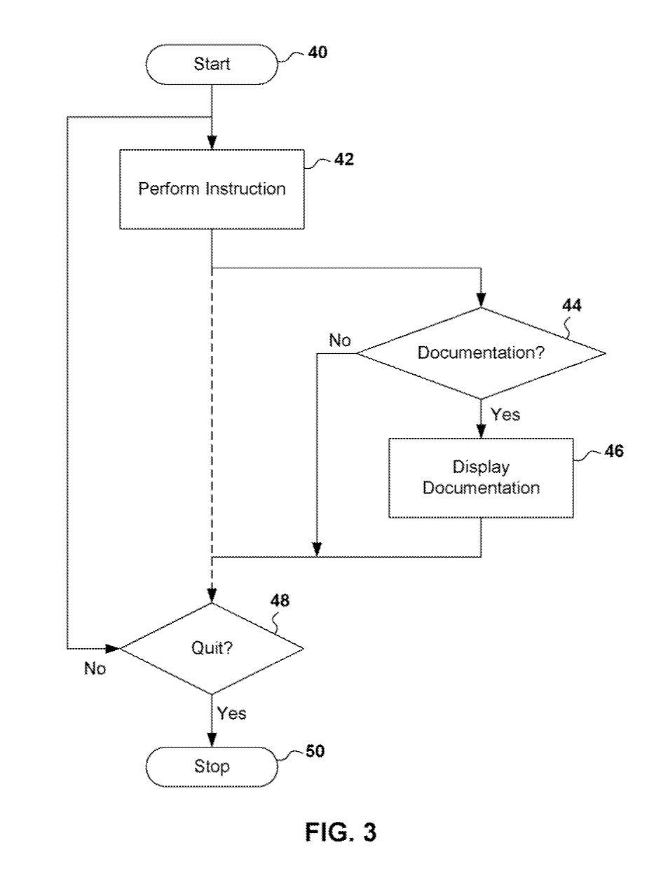

FIG. 3 summarizes the method that the data processing system 10 is executing, starting with the start 40. The executing environment 12 is performing an instruction from the sample program 16, which executing instruction will be presented by the display device 14 via the image 20 of the sample program 16. Under the control of the rule 28, when an instruction calls the API 18, a check is made at step 44 to see if information concerning the instruction is present embedded in the API 18. If such information is present, then at step 46 the information is displayed by the help window 26. Following the step 46, the sample program 16 will make a check to see if a quit instruction has been made by the user, and if not, the program 16 will continue running. If the user decides to quit, then the method will terminate at step 50.

The relationship between a sample program and the API can also be used when a programmer is dealing with a program at a higher level than a simple explanation of how an instruction call is handled by an API. For example, the user could be working with an application at higher level that will access multiple APIs for different purposes.

In a stock ticker application that uses a publish/subscribe API, the stock ticker application acts as the sample program and is so configured, via the addition of the rule 28, that if the user clicks on a button, for example to add a company to the ticker, the help window 26 will be updated to indicate that a subscribe method is being called, its uses, and the meaning of each of its parameters. This provides the developer wishing to develop using, the publish/subscribe API with an immediate, yet detailed idea of what methods would need to be invoked in a similar application.

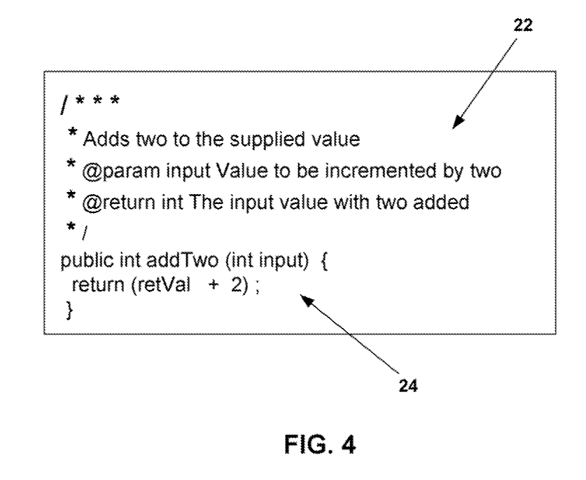

FIG. 4 shows a sample of code that would appear in an API module 18, which includes the source code 24 for an application call and also the associated information 22 that would be displayed in the help window 26, by the display device 14. Within the API 18, each piece of source code 24 will ideally have an associated information component 22, that can be accessed as and when needed.

What is claimed is:

1. A data processing method for operating a sample program and a related application programming interface comprising:
executing instructions of the sample program; and,
for each specific instruction that includes a call to the related application programming interface, accessing information associated with the application programming interface relating to the specific instruction and presenting the information relating to the specific instruction.

2. A method according to claim 1, wherein the sample program includes a user controllable rule, the rule controlling the access of the information associated with the application programming interface relating to the specific instruction.

3. A method according to claim 1, wherein the application programming interface comprises a source module of source code and said information associated with the application programming interface.

4. A method according to claim 1, wherein the step of accessing information associated with the application programming interface for each specific instruction comprises combining a plurality of individual information components into a single application programming interface documentation module.

5. A method according to claim 1, further comprising presenting the executing instructions of the sample program.

6. A method according to claim 1, wherein the information associated with application programming interface is embedded in the application programming interface.

7. A data processing system comprising an executing environment for operating a sample program and a related application programming interface, and a display device, the executing environment arranged to execute instructions of the sample program, and, for each specific instruction comprising a call to the related application programming interface, to access information associated with the application programming interface relating to the specific instruction, the display device arranged to present the information relating to the specific instruction.

8. A system according to claim 7, wherein the sample program includes a user controllable rule, the rule controlling the access of the information associated with the application programming interface relating to the specific instruction.

9. A system according to claim 7, wherein the application programming interface comprises a source module comprising source code and said information associated with the application programming interface.

10. A system according to claim 7, wherein the executing environment when accessing information associated with the application programming interface for each specific instruction is further arranged to combine a plurality of individual information components into a single application programming interface documentation module.

11. A system according to claim 7, wherein the executing environment is further arranged to present the executing instructions of the sample program.

12. A system according to claim 7, wherein the information associated with application programming interface is embedded in the application programming interface.

13. A computer program product for operating a sample program and a related application programming interface, the computer program product comprising a computer readable medium having computer readable program code embedded therein, the computer readable program code comprising:
computer readable program code configured to execute instructions of the sample program; and,
computer readable program code configured to access, for each specific instruction that includes a call to the related application programming interface, information associated with the application programming interface relating to the specific instruction and to present the information relating to the specific instruction.

14. A computer program product according to claim 13, wherein the sample program includes a user controllable rule for controlling the access of the information associated with the application programming interface relating to the specific instruction.

15. A computer program product according to claim 13, wherein the application programming interface comprises a module comprising source code and said information associated with the application programming interface.

16. A computer program product according to claim 13, wherein the computer readable program code configured to access information associated with the application programming interface for each specific instruction comprises computer readable program code configured to combine a plurality of individual information components into a single application programming interface documentation module.

17. A computer program product according to claim 13, further comprising computer readable program code configured to present the executing instructions of the sample program.

18. A computer program product according to claim 13, wherein the information associated with application programming interface is embedded in the application programming interface.
